(19) United States
(12) Patent Application Publication
(10) Pub. No.: US 2025/0113147 A1
(43) Pub. Date: Apr. 3, 2025

(54) SPEAKER

(71) Applicant: AAC Technologies (Nanjing) Co., Ltd., Nanjing (CN)

(72) Inventors: Yao Hui, Nanjing (CN); Weimin Chen, Nanjing (CN); Jie Ma, Nanjing (CN); Xingchi Chen, Nanjing (CN)

(21) Appl. No.: 18/398,209

(22) Filed: Dec. 28, 2023

Related U.S. Application Data
(63) Continuation of application No. PCT/CN2023/122794, filed on Sep. 28, 2023.

(51) Int. Cl. H04R 9/02; H04R 1/02; H04R 7/12; H04R 7/18; H04R 9/04

(52) U.S. Cl. CPC H04R 9/025; H04R 7/127; H04R 7/18; H04R 9/043; H04R 1/025; H04R 2209/027

(57) ABSTRACT

A speaker includes housing having receiving space and sound-producing unit received in receiving space. The sound-producing unit includes frame; vibration unit; magnetic circuit unit; spring damping element elastically connects magnetic circuit unit to frame and supports magnetic circuit unit to vibrate in accommodating space. A weight is fixed to magnetic circuit unit. In speaker, magnet or yoke and spring damping element form another vibration unit. This another vibration unit and the vibration unit that is composed of voice diaphragm, dome, and voice coil are subjected to interaction forces and vibrate in opposite directions, which reduces force on frame. The weight is added to magnetic circuit unit, which reduces the impact of air in rear cavity on magnet. Moreover, by adjusting mass of weight and stiffness and damping of spring damping element, corresponding resonant frequency and damping of magnetic circuit unit may be set, thereby achieving an optimal vibration isolation effect.

### TECHNICAL FIELD

The present disclosure relates to the field of acoustoelectric conversion technologies, and in particular, to a speaker.

### BACKGROUND

In recent years, an information technology has developed rapidly, and an audio device has become more and more popular. People require video and audio playback of the audio device, and also put forward more requirements for reliability of the audio device. In particular, with the arrival of the 5G era, a mobile multimedia technology has also developed. Many audio devices have a variety of entertainment functions, such as video playback, digital photography, games, and GPS navigation. With more and more functional requirements, components therein are becoming more and more integrated, and requirements for quality of products are becoming more and more stringent.

In the audio device, a speaker is a common electronic component, mainly configured for playback of audio signals, whose structural design directly affects quality of audio playback. An existing speaker includes a frame, a magnetic circuit unit received in the frame, and a vibration unit. When a voice coil in the vibration unit vibrates, a fixed boundary is subjected to a force, and the force may be transferred to an outer shell of a mobile terminal. Near a resonant frequency or when an excitation voltage is large, the fixed boundary is prone to an excessive force, causing obvious shell vibration, thereby affecting user experience.

Therefore, it is necessary to provide a new speaker to solve the above technical problems.

### SUMMARY

An objective of the present disclosure is to provide a speaker that can achieve an optimal damping effect under a condition that the entire unit is placed in a closed housing.

In order to achieve the above objective, the present disclosure provides a speaker. The speaker includes a housing having a receiving space, a sound outlet penetrating the housing and communicated with the receiving space, and a sound-producing unit received in the receiving space and fixed to the housing; the sound-producing unit dividing the receiving space into a front cavity and a rear cavity, the front cavity being communicated with the sound outlet, and a sound-producing side of the sound-producing unit facing the sound outlet, wherein the sound-producing unit includes:
a frame fixed to the housing and having an accommodating space, a vibration unit placed in the accommodating space, a magnetic circuit unit configured to drive the vibration unit to vibrate and produce sound, and a spring damping element elastically connecting the magnetic circuit unit to the frame; the vibration unit including a diaphragm with an outer periphery fixed to the frame and a voice coil driving the diaphragm to vibrate and produce sound; the magnetic circuit unit being provided with a magnetic gap, and the voice coil and the diaphragm being fixed to and inserted into the magnetic gap;
the spring damping element supporting the magnetic circuit unit to vibrate in the accommodating space; and the sound-producing unit further includes
a weight received in the rear cavity and fixed to the magnetic circuit unit.

Optionally, the magnetic circuit unit includes a yoke and a magnet fixed to the yoke, the yoke including a yoke bottom wall and a side wall bending and extending from an outer periphery of the yoke bottom wall; the magnet and the side wall are spaced apart to form the magnetic gap; and the spring damping element is fixedly connected to the side wall or the yoke bottom wall, and the weight is fixed to a side of the yoke bottom wall away from the magnet.

Optionally, the spring damping element includes a first stiffness layer, a damping layer stacked on and fixed to the first stiffness layer, and a second stiffness layer stacked on and fixed to the damping layer.

Optionally, the spring damping element is made of one or more of a high-damping simple-substance material, a high-damping polymer composite material, and a damping metal composite structure.

Optionally, the yoke is in a shape of a rectangle, two spring damping elements are provided, and the two spring damping elements are respectively located on opposite sides of a minor axis of the yoke or on opposite sides of a major axis of the yoke.

Optionally, the spring damping element includes an inner fixing portion fixed to one side of the yoke bottom wall close to the diaphragm, an outer fixing portion fixed to the bottom of the frame, and an elastic arm connecting the inner fixing portion and the outer fixing portion.

Optionally, the weight is attached to opposite sides of the yoke bottom wall close to the rear cavity, or is attached to a geometric center of the yoke bottom wall, or is attached around a periphery of the yoke bottom wall.

Optionally, the two spring damping elements are respectively located on the opposite sides of the minor axis of the yoke, two weights are provided, the two weights are respectively fixed to the yoke bottom wall and spaced apart, and the two weights are symmetrically arranged about the minor axis of the yoke bottom wall.

Optionally, the vibration unit further includes a dome covering a surface of the diaphragm.

Optionally, the housing includes a lower cover and an upper cover covering and fixed to the lower cover, the sound outlet is arranged on the upper cover, the sound-producing unit is supported on the upper cover, and the sound-producing unit, the upper cover, and the lower cover jointly define the rear cavity.

Compared with the related art, in the present disclosure, a spring damping element is added to the speaker, the spring damping element has one end connected to the magnet or the yoke and the other end connected to the frame, and the magnet or the yoke and the spring damping element form another vibration unit. The vibration unit and the vibration unit composed of a voice diaphragm, the dome, and the voice coil are subjected to interaction forces and vibrate in opposite directions, which reduces a force on the frame. The weight is added to the magnetic circuit unit, which reduces the impact of air in the rear cavity on the magnet. Moreover, by adjusting mass of the weight and stiffness and damping of the spring damping element, a corresponding resonant frequency and damping of the magnetic circuit unit may be set, thereby achieving an optimal vibration isolation effect.

### BRIEF DESCRIPTION OF DRAWINGS

In order to more clearly illustrate the technical solutions in embodiments of the present disclosure or the related art, the accompanying drawings used in the description of the embodiments or the related art will be briefly introduced below. It is apparent that, the accompanying drawings in the following description are only some embodiments of the present disclosure, and other drawings can be obtained by those of ordinary skill in the art from the provided drawings.

FIG. 1 is a schematic diagram of a three-dimensional structure of a speaker according to an embodiment of the present disclosure;

FIG. 2 is a schematic exploded view of the three-dimensional structure of the speaker according to an embodiment of the present disclosure;

FIG. 3 is a schematic structural diagram of a spring damping element of the speaker according to an embodiment of the present disclosure;

FIG. 4 is a sectional view taken along a line A-A shown in FIG. 1; and

FIG. 5 is a sectional view taken along a line B-B shown in FIG. 1.

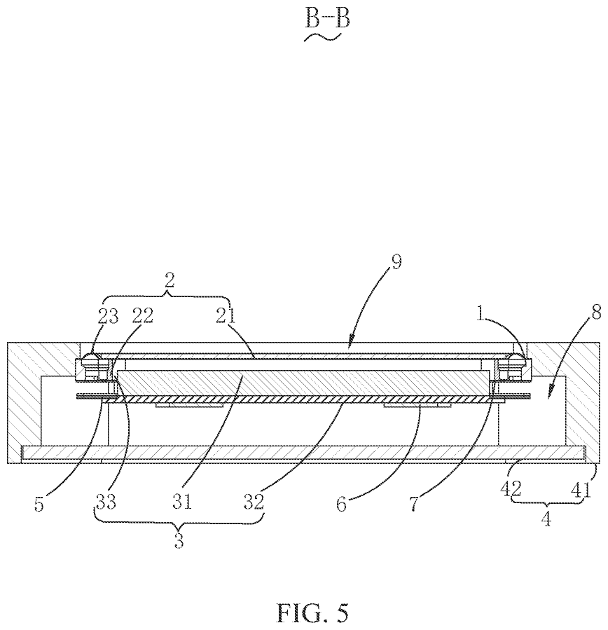

### DESCRIPTION OF EMBODIMENTS

The technical solutions in the embodiments of the present disclosure will be described clearly and completely below with reference to the accompanying drawings in the embodiments of the present disclosure. It is apparent that the described embodiments are merely some of rather than all of the embodiments of the present disclosure. All other embodiments acquired by those of ordinary skill in the art without creative efforts based on the embodiments in the present disclosure shall fall within the protection scope of the present disclosure.

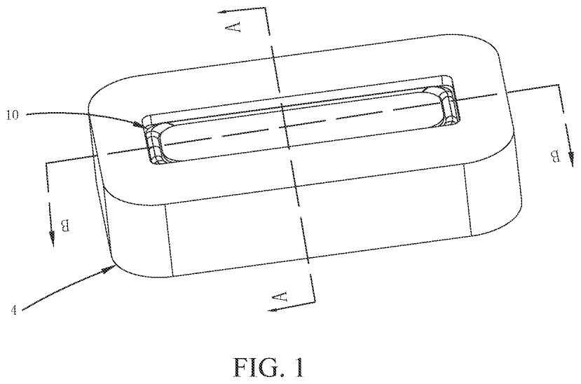

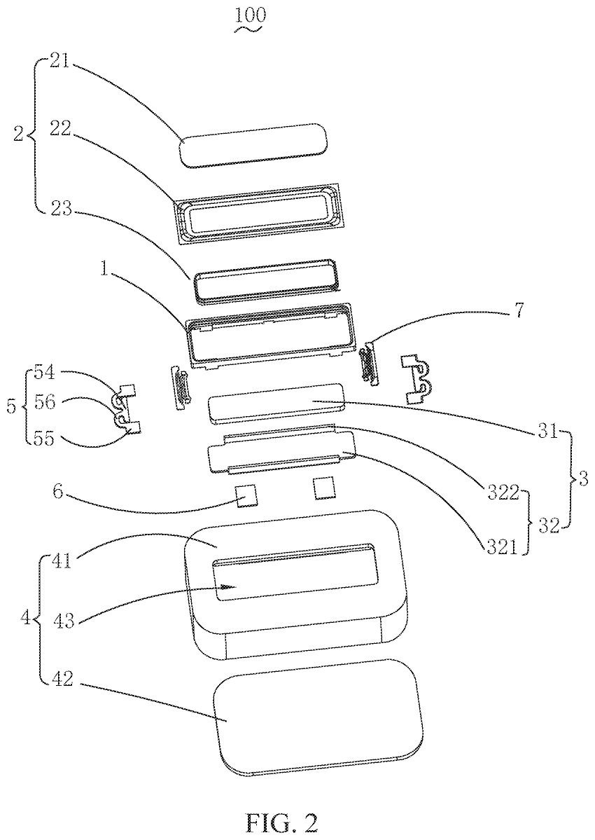

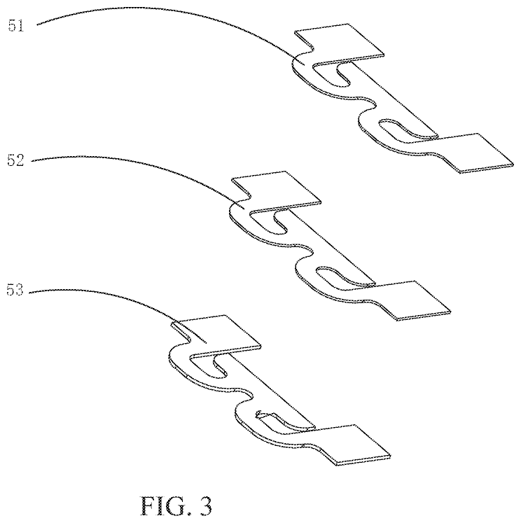

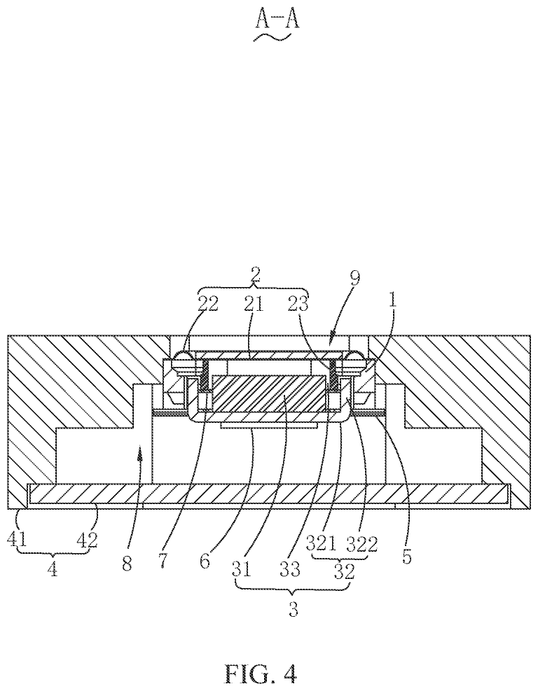

Referring to FIG. 1 to FIG. 4, an embodiment of the present disclosure provides a speaker 100. The speaker 100 includes a housing 4, a sound outlet 43 penetrating the housing 4 and communicated with the receiving space, and a sound-producing unit 10 received in the receiving space and fixed to the housing 4. The sound-producing unit 10 divides the receiving space into a front cavity 9 and a rear cavity 8. The front cavity 9 communicates with the sound outlet 43. A sound-producing side of the sound-producing unit 10 faces the sound outlet 43. The sound-producing unit 10 includes a frame 1, a vibration unit 2, a magnetic circuit unit 3, a spring damping element 5, a weight 6, and an elastic support component 7.

The frame 1 is fixed to the housing 4 and has an accommodating space. The vibration unit 2 and the magnetic circuit unit 3 are placed in the accommodating space. The magnetic circuit unit 3 is configured to drive the vibration unit 2 to vibrate and produce sound. The vibration unit 2 includes a diaphragm 22 with an outer periphery fixed to the frame 1 and a voice coil 23 driving the diaphragm 22 to vibrate and produce sound.

In this embodiment, the vibration unit 2 further includes a dome 21 covering a surface of the diaphragm 22.

In this embodiment, the magnetic circuit unit 3 includes a yoke 32 fixed to the frame 1 and a magnet 31 fixed to the yoke 32. The yoke 32 includes a yoke bottom wall 321 and a side wall 322 bending and extending from an outer periphery of the yoke bottom wall 321 and fixed to the yoke 32. The magnet 31 and the side wall 322 are spaced apart to form the magnetic gap 34. The voice coil 23 and the diaphragm 22 are fixed to and inserted into the magnetic gap 34. The spring damping element 5 is fixedly connected to the side wall 322 or the yoke bottom wall 321, and the weight 6 is fixed to a side of the yoke bottom wall 321 away from the magnet 31.

In this embodiment, the housing 4 further includes a lower cover 42 and an upper cover 41 covering and fixed to the lower cover 42, the sound outlet 43 is arranged on the upper cover 41, the sound-producing unit 10 is supported on the upper cover 41, and the sound-producing unit 10, the upper cover 41, and the lower cover 42 jointly define the rear cavity 8.

In this embodiment, the spring damping element 5 elastically connects the magnetic circuit unit 3 to the frame 1, and the spring damping element 5 is configured to support the magnetic circuit unit 3 to vibrate in the accommodating space. The spring damping element 5 and the magnet 31 or the yoke 32 form another vibration unit other than the vibration unit 2. The vibration unit and the vibration unit 2 composed of a voice diaphragm 22, the dome 21, and the voice coil 23 are subjected to interaction forces and vibrate in opposite directions, which reduces a force on the frame 1. A damping effect can be optimized by adjusting stiffness and damping of the spring damping element 5.

In this embodiment, the spring damping element 5 includes a first stiffness layer 51, a damping layer 52 stacked on and fixed to the first stiffness layer, and a second stiffness layer 53 stacked on and fixed to the damping layer 52. It is to be noted that a structure of the spring damping element 5 is not limited to three layers, which may be a similar multi-layer sandwich structure implemented based on the above structure. All the above are feasible and based on a same principle.

In this embodiment, the spring damping element 5 is made of one or more of a high-damping simple-substance material (such as damping rubber or foam), a high-damping polymer composite material (such as a particle-doped fiber-doped and laminate composite material), and a damping metal composite structure (such as high-damping metal or a constrained layer damping structure).

In this embodiment, two spring damping elements 5 are provided, and the two spring damping elements 5 are respectively located on opposite sides of a minor axis of the yoke 32 or on opposite sides of a major axis of the yoke 32.

In this embodiment, the spring damping element 5 includes an inner fixing portion 54 fixed to one side of the yoke bottom wall 321 close to the diaphragm 22, an outer fixing portion 55 fixed to the bottom of the frame 1, and an elastic arm 56 connecting the inner fixing portion 54 and the outer fixing portion 55.

In this embodiment, the weight 6 is fixed to the magnetic circuit unit 3. The weight 6 effectively reduces the impact of air in the rear cavity 8 on the magnet 31. At the same time, the magnet 31 and soft magnets may also be partially reduced, and the reduced part is replaced with the weight 6, to achieve basically a same basic configuration.

In this embodiment, the weight 6 is attached to opposite sides of the yoke bottom wall 321 close to the rear cavity 8, or is attached to a geometric center of the yoke bottom wall 321, or is attached around a periphery of the yoke bottom wall 321.

In this embodiment, the two spring damping elements 5 are respectively located on the opposite sides of the minor axis of the yoke 32, two weights 6 are provided, the two weights 6 are respectively fixed to the yoke bottom wall 321 and spaced apart, and the two weights 6 are symmetrically arranged about the minor axis of the yoke bottom wall 321.

In this embodiment, the elastic support component 7 is arranged in a space on opposite sides of a minor axis of the frame 1, and the elastic support component 7 has one end fixed to the frame 1 and the other end fixed to the voice coil 23. The elastic support component 7, on the one hand, is configured to enhance the vibration effect of the diaphragm 22 and improve acoustic performance of the speaker 100, and on the other hand, is configured to balance swing of the vibration unit 2 and improve stability of the speaker 100.

Compared with the related art, in the present disclosure, a spring damping element is added to the speaker, the spring damping element has one end connected to the magnet or the yoke and the other end connected to the frame, and the magnet or the yoke and the spring damping element form another vibration unit. This another vibration unit and the vibration unit composed of the voice diaphragm, the dome, and the voice coil are subjected to interaction forces and vibrate in opposite directions, which reduces a force on the frame. The weight is added to the magnetic circuit unit, which reduces the impact of air in the rear cavity on the magnet. Moreover, by adjusting mass of the weight and stiffness and damping of the spring damping element, a corresponding resonant frequency and damping of the magnetic circuit unit may be set, thereby achieving an optimal vibration isolation effect.

It is to be noted that, if other sound-producing manners are adopted but the unit is a dual vibration unit designed in the patent, the unit still falls within the scope of the patent. In the present disclosure, the rear cavity is arranged on one side of the speaker unit. If other rear cavity structures are designed and filled with various sound-absorbing materials but the speaker unit is a dual vibration unit designed in the present disclosure, the speaker unit still falls within the scope of the present disclosure. If the module structure is different from the structure shown in the present disclosure but the unit is a dual vibration unit designed in the present disclosure, the unit still falls within the scope of the present disclosure.

The connection during assembly in the present disclosure is mainly glue connection. If other connection manners are used but the unit is a dual vibration unit designed in the present disclosure, the unit still falls within the scope of the patent.

The above describes merely embodiments of the present disclosure. It should be pointed out herein that, for those of ordinary skill in the art, improvements can be made without departing from the creative concept of the present disclosure, all of which fall within the protection scope of the present disclosure.

What is claimed is:

1. A speaker, comprising: a housing having a receiving space; a sound outlet penetrating the housing and communicated with the receiving space; and a sound-producing unit received in the receiving space and fixed to the housing;
wherein the sound-producing unit divides the receiving space into a front cavity and a rear cavity, the front cavity communicates with the sound outlet, and a sound-producing side of the sound-producing unit faces the sound outlet,
wherein the sound-producing unit comprises: a frame fixed to the housing and having an accommodating space; a vibration unit placed in the accommodating space; a magnetic circuit unit configured to drive the vibration unit to vibrate and produce sound; and a spring damping element elastically connecting the magnetic circuit unit to the frame;
wherein the vibration unit comprises a diaphragm with an outer periphery fixed to the frame; and a voice coil driving the diaphragm to vibrate and produce sound;
wherein the magnetic circuit unit is provided with a magnetic gap, and the voice coil and the diaphragm is fixed to and inserted into the magnetic gap; the spring damping element is configured to support the magnetic circuit unit to vibrate in the accommodating space; and the sound-producing unit further comprises a weight received in the rear cavity and fixed to the magnetic circuit unit.

2. The speaker as described in claim 1, wherein the magnetic circuit unit comprises a yoke and a magnet fixed to the yoke; the yoke comprises a yoke bottom wall and a side wall bending and extending from an outer periphery of the yoke bottom wall; the magnet and the side wall are spaced apart to form the magnetic gap; and the spring damping element is fixedly connected to the side wall or the yoke bottom wall, and the weight is fixed to a side of the yoke bottom wall away from the magnet.

3. The speaker as described in claim 1, wherein the spring damping element comprises a first stiffness layer, a damping layer stacked on and fixed to the first stiffness layer, and a second stiffness layer stacked on and fixed to the damping layer.

4. The speaker as described in claim 1, wherein the spring damping element is made of one or more of a high-damping simple-substance material, a high-damping polymer composite material, and a damping metal composite structure.

5. The speaker as described in claim 2, wherein the yoke is in a shape of a rectangle, two spring damping elements are provided, and are respectively located on opposite sides of a minor axis of the yoke or on opposite sides of a major axis of the yoke.

6. The speaker as described in claim 5, wherein the spring damping element comprises an inner fixing portion fixed to one side of the yoke bottom wall close to the diaphragm, an outer fixing portion fixed to the bottom of the frame, and an elastic arm connecting the inner fixing portion to the outer fixing portion.

7. The speaker as described in claim 5, wherein the weight is attached to opposite sides of the yoke bottom wall close to the rear cavity, or is attached to a geometric center of the yoke bottom wall, or is attached around a periphery of the yoke bottom wall.

8. The speaker as described in claim 7, wherein the two spring damping elements are respectively located on the opposite sides of the minor axis of the yoke, two weights are provided, the two weights are respectively fixed to the yoke bottom wall and spaced apart from each other, and the two weights are symmetrically arranged about the minor axis of the yoke bottom wall.

9. The speaker as described in claim 1, wherein the vibration unit further comprises a dome covering a surface of the diaphragm.

10. The speaker as described in claim 1, wherein the housing comprises a lower cover and an upper cover covering and fixed to the lower cover, the sound outlet is arranged on the upper cover, the sound-producing unit is supported on the upper cover, and the sound-producing unit, the upper cover and the lower cover jointly define the rear cavity.
